(19) United States
(12) Patent Application Publication
(10) Pub. No.: US 2024/0169970 A1
(43) Pub. Date: May 23, 2024

(54) VIRTUAL ENGINE SOUND GENERATING DEVICE FOR EMBEDDED SYSTEM AND CONTROL METHOD THEREOF

(71) Applicant: HYUNDAI MOBIS CO., LTD., Seoul (KR)

(72) Inventor: Jae Young LEE, Icheon-si (KR)

(73) Assignee: HYUNDAI MOBIS CO., LTD., Seoul (KR)

(21) Appl. No.: 18/497,776

(22) Filed: Oct. 30, 2023

(30) Foreign Application Priority Data
Nov. 22, 2022 (KR) 10-2022-0157534

(51) Int. Cl. G10K 15/02; H04R 3/04

(52) U.S. Cl. CPC G10K 15/02; H04R 3/04; H04R 2499/13

(57) ABSTRACT

Provided are a virtual engine sound generating device for an embedded system and a control method thereof. The virtual engine sound generating device includes an input unit receiving sound source information, a signal generating unit compensating for a phase for each frequency with respect to all frequencies of the sound source information to generate corrected sound source information, and an output unit providing final sound source information based on the corrected sound source information.

### CROSS-REFERENCE TO RELATED APPLICATIONS

This application claims priority under 35 U.S.C. § 119 to Korean Patent Application No. 10-2022-0157534, filed on Nov. 22, 2022, in the Korean Intellectual Property Office, the disclosure of which is incorporated herein by reference in its entirety.

### TECHNICAL FIELD

The following disclosure relates to a virtual engine sound generating device and a control method thereof, and in particular, to a virtual engine sound generating device for an embedded system and a control method thereof.

### BACKGROUND

Electronic active sound design (EASD) is a method of generating and outputting a virtual engine sound from an interior speaker of electric vehicles, which may improve the drivers' sense of immersion in driving. Recently, in order to better represent the brand of an electric vehicle, a wavetable or granular synthesizer method using a sound source, while using, as an engine sound, future-oriented or spaceship sound, breaking away from traditional engine sound, has been used. When creating a sound using a sound source, the sound may be enriched when a frequency of the sound source is modulated and simultaneously output. Representatively, by changing a length using a phase vocoder, which is a time scale modification (TSM) method, and then changing a sampling frequency, a sound having the same length as that of the original sound source, while having a different frequency band, may be created. In addition, a driver may hear an actual engine sound with different tones by adjusting the magnitude of a frequency-modulated sound source, such as an order component of the engine, according to driving situations.

Phase vocoders, which are a representative TSM technology, have been used in many audio processing fields because results of a length change of sound sources are natural. Since the phase vocoder predicts an accurate frequency for only a frequency component having a maximum value by comparing a phase of the frequency component with a phase of a previous frequency response and correcting a phase of the corresponding frequency component using the predicted frequency, the phase vocoder may achieve continuity without a rapid phase change.

However, vertical phase coherence of a sound source, that is, a sine difference phase relationship, is lost. Since the vertical phase coherence affects waveform changes, such as a transient phenomenon, the transient phenomenon may disappear from a phase vocoder output signal sometimes. In addition, an artificial structure is added, such as adding directionality to the tones. In order to use the phase vocoder in an EASD embedded controller, the phase vocoder may need to be implemented in a limited calculation amount or memory capacity, while a phase vocoder used in a high-quality sound source expansion has a narrow gap between an analysis frame and a synthesis frame, so a number of frames should be processed to process the entire sound sources. Therefore, a large amount of calculation is inevitably required. In addition, since a frequency response of two frames is used, memory usage is large, and since a control process of detecting the maximum frequency and predicting an accurate frequency for the detected frequency is required, it is difficult to implement with a hardware accelerator.

### SUMMARY

A virtual engine sound generating device for an embedded system and a control method according to an exemplary embodiment of the present invention is directed to providing a phase compensating device using a time delay value to change a length of a sound source in an embedded environment and a control method thereof.

In one general aspect, a virtual engine sound generating device includes: an input unit receiving sound source information; a signal generating unit generating an input signal based on the sound source information and compensating for a phase for each frequency with respect to all frequencies of the input signal to generate corrected sound source information; and an output unit providing final sound source information based on the corrected sound source information.

The signal generating unit may generate, as the input signal, an analysis frame that is a frame repeatedly extracted from the sound source information at a hop-in interval.

The signal generating unit may process the analysis frame to generate a synthesis frame, generate a fixed delay value based on a difference in position between the analysis frame and the synthesis frame, and compensate for a phase for each frequency of the input signal based on the fixed delay value.

The signal generating unit may multiply the input signal by a window to generate a windowing signal, apply fast Fourier transform (FFT) to the windowing signal to convert the windowing signal into a frequency domain signal, apply the fixed delay value to the frequency domain signal for each frequency to generate a phase compensation signal, and apply inverse FFT (IFFT) to the phase compensation signal to output corrected sound source information.

The output unit may provide the final sound source information based on the corrected sound source information and a hop-out interval.

The virtual engine sound generating device may further include a comparing unit comparing a sum of the hop-in interval and a length of the analysis frame with a length of the sound source information.

The virtual engine sound generating device may further include: a low pass filter (LPF) allowing only a low frequency component to pass therethrough, wherein the LPF may receive the final sound source information, eliminate a difference in phase from the synthesis frame, and output a corresponding result.

In another general aspect, a control method of a virtual engine sound generating device includes: (a) receiving sound source information; (b) generating an input signal based on the sound source information and compensating for a phase for each frequency with respect to all frequencies of the input signal to generate corrected sound source information; and (c) providing final sound source information based on the corrected sound source information.

The control method may further include: after operation (a) and before operation (b), (a-1) generating, as the input signal, an analysis frame that is a frame repeatedly extracted from the sound source information at a hop-in interval.

Operation (b) may include: processing the analysis frame to generate a synthesis frame, generating a fixed delay value based on a difference in position between the analysis frame and the synthesis frame, and compensating for a phase for each frequency of the input signal based on the fixed delay value.

Operation (b) may include: (b-1) multiplying the input signal by a window to generate a windowing signal; (b-2) applying FFT to the windowing signal to convert the windowing signal into a frequency domain signal; (b-3) applying the fixed delay value to the frequency domain signal for each frequency to generate a phase compensation signal; and (b-4) applying IFFT to the phase compensation signal to output corrected sound source information.

Operation (c) may include providing the final sound source information based on the corrected sound source information and a hop-out interval.

The control method may further include: after operation (c), (c-1) comparing a sum of the hop-in interval and a length of the analysis frame with a length of the sound source information, wherein operation (c-1) includes returning to operation (a-1) when the length of the sound source information is greater; and providing the final sound source information when the length of the source source information is smaller.

The control method may further include: after operation (c-1), (c-2) receiving, by a low pass filter (LPF), the final sound source information, eliminating a difference in phase from the synthesis frame, and outputting a corresponding result.

Other features and aspects will be apparent from the following detailed description, the drawings, and the claims.

### BRIEF DESCRIPTION OF THE DRAWINGS

FIG. 1 is a diagram illustrating a method of changing a length of a sound source based on a phase vocoder of the related art;

FIG. 2 is a diagram illustrating a control method of a virtual engine sound generating device according to an exemplary embodiment of the present invention;

FIG. 3 is a diagram illustrating a phase compensating method of each frame according to an exemplary embodiment of the present invention;

FIG. 4 is a diagram illustrating a signal generated according to a control method of a virtual engine sound generating device according to the present invention; and

FIG. 5 is a diagram illustrating a comparison between the amount of calculation and memory usage according to the phase vocoder method of the related art and an exemplary embodiment of the present invention.

### DETAILED DESCRIPTION

In order to describe the present invention, the operational advantages of the present invention, and the objects achieved by the practice of the present invention, exemplary embodiments of the present invention are described.

Terms used in the present application are used only to describe specific exemplary embodiments and are not intended to limit the present invention. A singular form may include a plural form if there is no clearly opposite meaning in the context. It will be further understood that the terms “comprises” or “have” used in this specification, specify the presence of stated features, numerals, components, parts, or a combination thereof, but do not preclude the presence or addition of one or more other features, numerals, components, parts, or a combination thereof.

In describing the present invention, if it is determined that a detailed description of a related known configuration or function may obscure the gist of the present invention, the detailed description will be omitted.

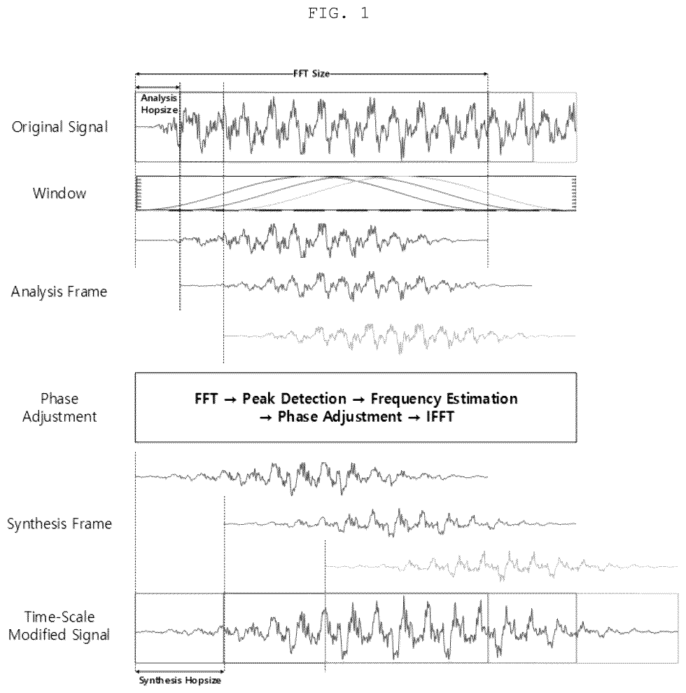

FIG. 1 is a diagram illustrating a method of changing a length of a sound source based on a phase vocoder of the related art.

Prior to describing the present invention, the related art method of changing a length of a sound source based on a phase vocoder will be described in detail with reference to FIG. 1.

First, a time scale modification (TSM) method used to change the length of a sound source is a method used to change the length of a sound source without changing frequency characteristics. Here, in the TSM method, an input signal may be divided into units of frames to change the length of a sound source. At this time, each frame is called an analysis frame, respective frames generally overlap each other, and a start interval is called an analysis hopsize. In addition, a synthesis frame may be generated by processing the analysis frame, and may be disposed at a location different from that of the input signal. At this time, the start interval of each frame is referred to as synthesis hopsize. Therefore, in the case of analysis hopsize>synthesis hopsize, a length of an output signal is reduced, and in the case of analysis hopsize<synthesis hopsize, the length of the output signal is increased. Meanwhile, when the analysis frame is moved to a location of the synthesis frame, a time point at which the frame is located changes, and thus, phase compensation is required to prevent a rapid phase shift. Specifically, when a start position of the analysis frame shown in FIG. 1 is tₐ and a start position of the synthesis frame is tₛ, when the start position of the analysis frame is moved to tₛ, which is the start position of the synthesis frame, the phase may be compensated using the following equation (Equation 1).

$$x ( t - ( {t}_{s} - {t}_{a} ) ) ↔ {e}^{- j 2 π f ( {t}_{s} - {t}_{a} )} X ( f ) \qquad [ Equation 1 ]$$

In addition, in order to prevent rapid phase shift due to frame rearrangement, the phase vocoder may perform weighting using a hanning window before processing the analysis frame and obtain a frequency response using fast Fourier transform (FFT). Thereafter, a main frequency component having a peak may be detected (peak detection), and a frequency having a higher accuracy than that of FFT resolution may be estimated (frequency estimation) using the equation (Equation 2) below based on a phase difference between a previous analysis frame of the corresponding frequency and a current frame.

$$Phase Difference = 2 π f \frac{Analysis Hopsize}{Sampling Frequency} + 2 π n , n ∈ N \qquad [ Equation 2 ]$$

At this time, the virtual engine sound generating device may correct the phase using Equation 1 described above before moving the position of the corresponding analysis frame to the position of the synthesis frame (phase adjustment), and thereafter, the virtual engine sound generating device may generate a signal obtained by changing a length of the phase-compensated signal using inverse FFT (IFFT). More specifically, when the length of the input signal is I, the length O of the output signal is as shown in equation (Equation 3) below.

$$0 = ⌊ \frac{I - F F T Size}{Analysis Hopsize} ⌋ \times Synthesis Hopsize + F F T Size \qquad [ Equation 3 ]$$

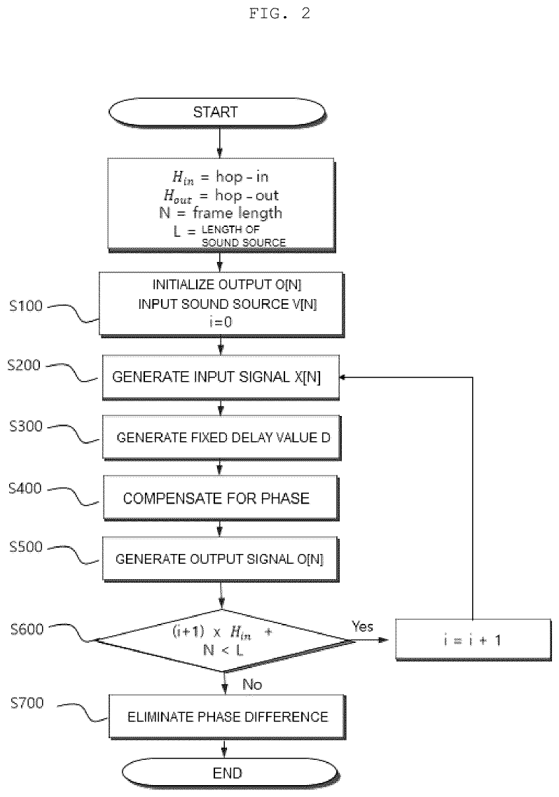

FIG. 2 is a diagram illustrating a control method of a virtual engine sound generating device according to an exemplary embodiment of the present invention;

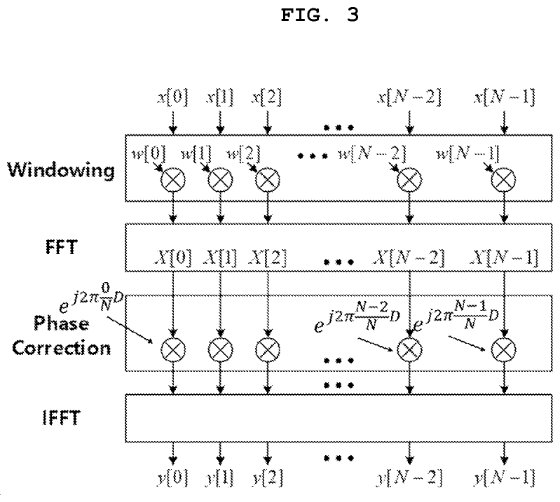

FIG. 3 is a diagram illustrating a phase compensating method of each frame according to an exemplary embodiment of the present invention;

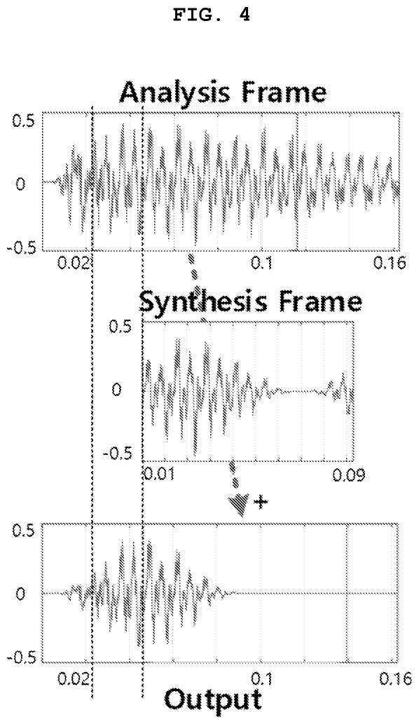

FIG. 4 is a diagram illustrating a signal generated according to a control method of a virtual engine sound generating device according to the present invention.

A control method of a virtual engine sound generating device according to an exemplary embodiment of the present invention will be described in detail with reference to FIGS. 2 to 4.

As shown in FIG. 2, a method of changing a length of sound source information v[n] having a length L according to an exemplary embodiment of the present invention may include an operation (S100) of initializing final sound source information o[n] as an output and receiving the sound source information v[n] (here, n is a natural number greater than or equal to 0 and less than N, and N is a length of a frame), an operation (S200) of generating, as an input signal x[n], an analysis frame that is a frame extracted by overlapping at an interval Hᵢₙ that is a hop-in interval from the sound source information v[n], an operation (S300) of generating a synthesis frame by processing the analysis frame and generating a fixed delay value D based on a position difference between the analysis frame and the synthesis frame, an operation (S400) of calculating corrected sound source information y[n] by compensating for a phase for the entire frequency components of the input signal x[n] based on the fixed delay value D by frame, an operation (S500) of generating final sound source information o[n], which is the output, based on Hₒᵤₜ that is a hop-out interval with the corrected sound source information y[n], and an operation (S600) of comparing the sum of the interval Hᵢₙ and N that is a length of the analysis frame with the length L of the sound source information and outputting the final sound source information o[n] based on a comparison result.

Specifically, the input signal x[n] may be expressed as follows:

$$x [ n ] = v [ n + i \times {H}_{i n} ] . \qquad [ Equation 4 ]$$

Also, the value of the first i may be 0.

Specifically, the fixed delay value D may be expressed as follows:

$$D = i \times ( {H}_{out} - {H}_{i n} ) . \qquad [ Equation 5 ]$$

More specifically, a method of compensating for a phase for each frame according to an exemplary embodiment of the present invention will be described in detail.

When arranging the analysis frame at the position of the synthesis frame, the virtual engine sound generating device may perform linear phase adjustment for each frequency as shown in FIG. 3 to structurally adjust the phase.

In other words, the virtual engine sound generating device may include a windowing operation, an FFT operation, a phase compensation operation, and an IFFT operation to adjust the phase.

More specifically, in the windowing operation, a windowing signal X_{w}[n] may be generated by multiplying x[n] by w[n], which is a window, and weighing the same. A window may be applied to reduce or eliminate an issue caused by discontinuity when the front and the end of a signal captured on a screen do not match during performing FFT. In this case, the window may be a hanning window.

In the FFT operation, the windowing signal X_{w}[n] may be converted into X[k], which is a signal in a frequency domain, by using FFT.

In the phase compensation operation, the generated fixed delay value D may be phase-compensated for each frequency with respect to X[k], and a phase compensation signal, Xₚₕₐₛₑ[k], may be generated.

In the IFFT operation, y[n], which is corrected sound source information in a time domain, may be output by applying IFFT to the generated phase compensation signal, Xₚₕₐₛₑ[k].

In other words, the windowing signal X_{w}[n] may be expressed as follows:

$${x}_{w} [ n ] = w [ n ] x [ n ] \qquad [ Equation 6 ]$$

The virtual engine sound generating device may eliminate a sudden change occurring in a region repeated through the windowing operation.

X[k], which is a signal in the frequency domain, may be expressed as follows:

$$X [ k ] = {\sum }_{n = 0}^{N - 1} {x}_{w} [ n ] {e}^{- j 2 π \frac{k}{N} n} \qquad [ Equation 7 ]$$

The phase compensation signal Xₚₕₐₛₑ[k] may be expressed as follows:

$${X}_{phase} [ k ] = X [ k ] {e}^{j 2 π \frac{k}{N} D} \qquad [ Equation 8 ]$$

The corrected sound source information y[n] may be expressed as follows:

$$y [ n ] = real ( \frac{1}{N} {\sum }_{k = 0}^{N} {X}_{phase} [ k ] {e}^{j 2 π \frac{n}{N} k} ) \qquad [ Equation 9 ]$$

In conclusion, the virtual engine sound generating device may linearly perform phase compensation through the aforementioned operations in order to compensate for the phase change due to the position difference between the analysis frame and the synthesis frame, and through this, vertical phase coherence may be maintained. In addition, the virtual engine sound generating device is capable of phase compensation for all frequency components instead of phase compensation for a few frequencies like Synchronous Overlap and Add or phase vocoder. Therefore, when the D, which is the fixed delay value according to a change in position of the frame, is input, there is an effect of implementing with a hardware accelerator because the calculation of each operation is fixed.

Referring back to FIG. 2, the operation (S500) of generating the final sound source information o[n], which is the output, based on the corrected sound source information y[n] and the hop-out interval Hₒᵤₜ may be expressed as follows:

$$o [ n + I \times {H}_{out} ] = o [ n + I \times {H}_{out} ] + y [ n ] . \qquad [ Equation 10 ]$$

In addition, the above operation S600 may be expressed as follows:

(I+1)×Hᵢₙ+N<L.

In other words, the sum of Hᵢₙ and N that is the length of the analysis frame is compared with the length L of the sound source information, and when the length L of the sound source information is larger, the process may return to operation S200 and may be performed again. At this time, i may be replaced with i+1.

In addition, after the operation S500, the virtual engine sound generating device may compare the sum of Hᵢₙ and N that is the length of the frame with the length L of the sound source information, and when the length L of the sound source information is smaller, the virtual engine sound generating device may output the output o[n+I×Hₒᵤₜ] as the final output o[n]. Specifically, the virtual engine sound generating device may further include operation (S700) of eliminating, by a low pass filter (LPF) allowing only a low frequency component to pass therethrough, a phase difference with the synthesis frame upon receiving the output o[n+I×Hₒᵤₜ] as an input, and outputting a corresponding result, after operation S600. Accordingly, an output as shown in FIG. 4 may be generated.

Overall, since the phase vocoder of the related art predicts the position of the synthesis frame using a change in phase between a previous analysis frame and a current analysis frame, the phase vocoder may accurately perform prediction as the interval of the analysis frames is smaller. Thus, if the constituting frequency component changes due to a large frame interval, distortion may significantly occur. However, with the aforementioned method, the phase of the input sound source may be preserved, and thus, the frame interval may be wider.

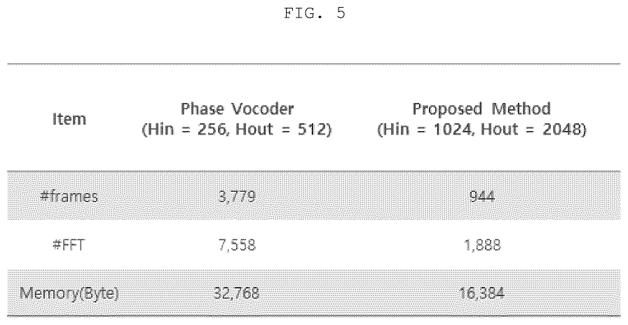

FIG. 5 is a table illustrating a comparison of the amount of calculation and memory usage between a phase compensating method according to the present invention and the phase vocoder of the related art.

FIG. 5 shows a change in the length of a sound source by twofold using a sound source having about 1 million samples in order to compare the amount of calculation and memory usage.

Since the phase compensating method according to the present invention may increase the frame interval four times more than the phase vocoder of the related art, it is possible to change the length of the sound source with four times less of the amount of calculation. In addition, since it is not necessary to store a frequency response of a previous frame, only half of the memory usage may be used for implementation. Therefore, in the case of using the phase compensating method according to the present invention, the length of the sound source may be changed even in an embedded environment, and thus, a richer virtual engine sound may be generated according to a driving situation.

In addition, the virtual engine sound generating device for changing the length L of v[n], which is the sound source information, may include an input unit, a signal generating unit, and an output unit (not shown).

The input unit receives the sound source information v[n].

The signal generating unit generates an input signal based on the sound source information, and compensates the phase for each frequency for all frequencies of the input signal to generate corrected sound source information.

The output unit provides final sound source information based on the corrected sound source information.

Specifically, the signal generating unit may generate an analysis frame, which is a frame repeatedly extracted from the sound source information v[n] at an interval Hᵢₙ, which is a hop-in interval, as an input signal x[n]. In this case, n is a natural number greater than or equal to 0 and less than N, and N refers to the length of the frame.

In addition, the signal generating unit may process the analysis frame to generate a synthesis frame, and generate a fixed delay value D based on a difference in position between the analysis frame and the synthesis frame. In addition, the signal generating unit may calculate the corrected sound source information y[n] by compensating for the phase by frame for the entire frequency components of the input signal x[n] based on the fixed delay value D.

Meanwhile, the output unit may generate the final sound source information o[n] as the output based on the corrected sound source information y[n] and the hop-out interval Hₒᵤₜ.

In addition, the virtual engine sound generating device may further include a comparing unit (not shown).

The comparing unit may compare the sum of Hᵢₙ and N that is the length of the analysis frame with the length L, and output the final sound source information o[n] based on a comparison result.

Specifically, the signal generating unit may generate the windowing signal X_{w}[n] by multiplying the input signal x[n] by w[n], which is a window, and weighting the same. In addition, the signal generating unit may convert the generated X_{w}[n] into a frequency domain signal X[k] using FFT. Thereafter, phase compensation may be performed on the frequency domain signal X[k] for each frequency based on the fixed delay value D generated by the signal processing unit to generate a phase compensation signal Xₚₕₐₛₑ[k]. In addition, corrected sound source information y[n] of the time domain may be output by applying IFFT to the generated Xₚₕₐₛₑ[k]. More specifically, the window may be a hanning window.

In addition, the present invention may further include an LPF that allows only a low frequency component to pass therethrough. The LPF may receive the final sound source information o[n] output from the comparing unit as an input, eliminate a phase difference from the synthesis frame, and output a corresponding result.

In conclusion, in order to compensate for the phase change of the analysis frame due to the position difference of the synthesis frame, phase compensation may be linearly performed through the device described above, and through this, vertical phase coherence may be maintained. In addition, phase compensation for all frequency components may be made instead of phase compensation for a few frequencies like Synchronous Overlap and Add or the phase vocoder. Therefore, when the D, which is a fixed delay value according to the position change of the frame, is input, there is an effect that may be implemented with a hardware accelerator because the calculation of each operation is fixed.

Overall, since the phase vocoder of the related art predicts the position of the synthesis frame using a change in phase of a previous analysis frame and a current analysis frame, the phase vocoder may accurately perform prediction as the interval of the analysis frames is smaller. Thus, if the constituting frequency component changes due to a large frame interval, distortion may significantly occur. However, with the aforementioned system, the phase of the input sound source may be preserved, and thus, the frame interval may be wider.

As described above, according to the virtual engine sound generating device for an embedded system and the control method according to various exemplary embodiments of the present invention, the calculation of each operation may be fixed by compensating the phase using the time delay value.

In addition, since vertical phase coherence may be maintained, the amount of calculation may be significantly reduced and memory usage may be reduced by about half, thereby implementing in an embedded system.

In addition, since it may be implemented as a hardware accelerator, the calculation occupancy of a processing unit may be minimized, and when the EASD function is included in a domain controller (DCU), it may be implemented with a small calculation amount, and thus, more functions may be loaded into the DCU, thereby improving UX and reducing costs.

Although the preferred exemplary embodiments of the present invention have been described above, the exemplary embodiments disclosed in the present invention are not intended to limit the technical spirit of the present invention, but are only for explanation. Therefore, the technical spirit of the present invention includes not only each disclosed exemplary embodiment, but also a combination of the disclosed exemplary embodiments, and furthermore, the scope of the technical spirit of the present invention is not limited by these exemplary embodiments. In addition, those skilled in the art to which the present invention pertains may make many changes and modifications to the present invention without departing from the spirit and scope of the appended claims, and all such appropriate changes and modifications, as equivalents, are to be regarded as falling within the scope of the present invention.

What is claimed is:

1. A virtual engine sound generating device comprising:
an input unit configured to receive sound source information;
a signal generating unit configured to generate a multi-frequency input signal based on the sound source information and to compensate for a phase for each frequency with respect to all frequencies of the input signal to generate corrected sound source information; and
an output unit configured to generate final sound source information based on the corrected sound source information.

2. The virtual engine sound generating device of claim 1, wherein the signal generating unit generates, as the input signal, an analysis frame that is a frame repeatedly extracted from the sound source information at a hop-in interval.

3. The virtual engine sound generating device of claim 2, wherein the signal generating unit processes the analysis frame to generate a synthesis frame, generates a fixed delay value based on a difference in position between the analysis frame and the synthesis frame, and compensates for a phase for each frequency of the input signal based on the fixed delay value.

4. The virtual engine sound generating device of claim 3, wherein the signal generating unit multiplies the input signal by a window to generate a windowing signal, applies fast Fourier transform (FFT) to the windowing signal to convert the windowing signal into a frequency domain signal, applies the fixed delay value to the frequency domain signal for each frequency to generate a phase compensation signal, and applies inverse FFT (IFFT) to the phase compensation signal to generate the output corrected sound source information.

5. The virtual engine sound generating device of claim 1, wherein the output unit generates the final sound source information based on the corrected sound source information and a hop-out interval.

6. The virtual engine sound generating device of claim 3, further comprising:
a comparing unit configured to compare a sum of the hop-in interval and a length of the analysis frame with a length of the sound source information.

7. The virtual engine sound generating device of claim 3, further comprising:
a low pass filter (LPF) configured to allow only a low frequency component of the final sound source information to pass therethrough,
wherein the LPF receives the final sound source information, eliminates a difference in phase from the synthesis frame, and outputs a corresponding result.

8. A control method of a virtual engine sound generating device, the control method comprising:
(a) receiving sound source information;
(b) generating a multi-frequency input signal based on the sound source information and compensating for a phase for each frequency with respect to all frequencies of the input signal to generate corrected sound source information; and
(c) providing final sound source information based on the corrected sound source information.

9. The control method of claim 8, further comprising:
after (a) and before (b):
(a-1) generating, as the input signal, an analysis frame that is a frame repeatedly extracted from the sound source information at a hop-in interval.

10. The control method of claim 9, wherein (b) further includes:
processing the analysis frame to generate a synthesis frame, generating a fixed delay value based on a difference in position between the analysis frame and the synthesis frame, and
compensating for a phase for each frequency of the input signal based on the fixed delay value.

11. The control method of claim 10, wherein (b) further includes:
(b-1) multiplying the input signal by a window to generate a windowing signal;
(b-2) applying fast Fourier transform (FFT) to the windowing signal to convert the windowing signal into a frequency domain signal;
(b-3) applying the fixed delay value to the frequency domain signal for each frequency to generate a phase compensation signal; and
(b-4) applying inverse FFT (IFFT) to the phase compensation signal to output corrected sound source information.

12. The control method of claim 8, wherein (c) includes providing the final sound source information based on the corrected sound source information and a hop-out interval.

13. The control method of claim 10, further comprising:
after (c):
(c-1) comparing a sum of the hop-in interval and a length of the analysis frame with a length of the sound source information,
wherein (c-1) includes returning to (a-1) when the length of the sound source information is greater than the sum of the hop-in interval and the length of the analysis frame; and
providing the final sound source information when the length of the sound source information is smaller than the sum of the hop-in interval and the length of the analysis frame.

14. The control method of claim 13, further comprising:
after (c-1),
(c-2) receiving, by a low pass filter (LPF), the final sound source information, eliminating a difference in phase from the synthesis frame, and outputting a corresponding result.
